(19) United States
(12) Patent Application Publication
(10) Pub. No.: US 2021/0365327 A1
(43) Pub. Date: Nov. 25, 2021

(54) METHOD, ELECTRONIC DEIVCE AND COMPUTER PROGRAM PRODUCT FOR CREATING SNAPVIEW BACKUP

(71) Applicant: EMC IP Holding Company LLC, Hopkinton, MA (US)

(72) Inventors: Yi Wang, Chengdu (CN); Chao Lin, Chengdu (CN)

(21) Appl. No.: 16/917,834

(22) Filed: Jun. 30, 2020

(30) Foreign Application Priority Data
May 25, 2020 (CN) 202010449309.4

(51) Int. Cl. G06F 11/14; H04L 29/06

(52) U.S. Cl. CPC G06F 11/1464; G06F 2201/84; G06F 2201/80; H04L 67/42

(57) ABSTRACT

Embodiments of the present disclosure relate creating a snapview backup. The embodiments include acquiring, at a backup client, a first file list corresponding to the snapview backup to be created at a backup server, the first file list indicating a plurality of files to be referenced by the snapview backup, and data of the plurality of files being contained in a plurality of containers at the backup server; generating a second file list by sorting the plurality of files indicated in the first file list according to the containers to which they belong, the second file list indicating that each of the plurality of containers contains data of at least one of the plurality of files; and causing the backup server to reference the data of the plurality of files in the plurality of containers based on the second file list, to create the snapview backup.

### CROSS-REFERENCE TO RELATED APPLICATIONS

The application claims priority to Chinese Patent Application No. 202010449309.4 filed on May 25, 2020. Chinese Patent Application No. 202010449309.4 is hereby incorporated by reference in its entirety.

### TECHNICAL FIELD

Embodiments of the present disclosure generally relate to the field of data storage, and in particular, to a method, an electronic device, and a computer-readable storage medium for creating a snapview backup.

### BACKGROUND

A backup system usually includes a backup client and a backup server, where the backup client can send files to be backed up to the backup server for backup. Many backup systems provide a function called snapview backup. This function will create a new backup by referencing data in existing backup files in the backup server.

In a disk image backup scenario, basic disk image files and changed data block files are usually created at different times, so there are usually two backup files created for them respectively in the backup server. When customers want to restore the latest disk image file, they need to restore the basic disk image files and the changed data block files, and then merge them to obtain the latest disk image file. This is often inconvenient for the customers.

### SUMMARY OF THE INVENTION

Embodiments of the present disclosure provide a method, an electronic device, and a computer-readable storage medium for creating a snapview backup.

In a first aspect of the present disclosure, there is provided a method for creating a snapview backup. The method includes: acquiring, at a backup client, a first file list corresponding to the snapview backup to be created, the first file list indicating a plurality of files to be referenced by the snapview backup, and data of the plurality of files being contained in a plurality of containers at a backup server; generating a second file list by sorting the plurality of files indicated in the first file list according to the containers to which they belong, the second file list indicating that each of the plurality of containers contains data of at least one of the plurality of files; and creating the snapview backup by causing the backup server to reference the data of the plurality of files in the plurality of containers based on the second file list.

In a second aspect of the present disclosure, there is provided an electronic device. The electronic device includes at least one processing unit and at least one memory. The at least one memory is coupled to the at least one processing unit and stores instructions for execution by the at least one processing unit. The instructions, when executed by the at least one processing unit, cause the device to perform actions, and the actions include: acquiring a first file list corresponding to a snapview backup to be created, the first file list indicating a plurality of files to be referenced by the snapview backup, and data of the plurality of files being contained in a plurality of containers at a backup server; generating a second file list by sorting the plurality of files indicated in the first file list according to the containers to which they belong, the second file list indicating that each of the plurality of containers contains data of at least one of the plurality of files; and creating the snapview backup by causing the backup server to reference the data of the plurality of files in the plurality of containers based on the second file list.

In a third aspect of the present disclosure, there is provided a computer-readable storage medium that contains machine-executable instructions. The machine-executable instructions, when executed by a device, cause the device to perform the method described according to the first aspect of the present disclosure.

In a fourth aspect of the present disclosure, there is provided a computer program product. The computer program product is tangibly stored in a computer-readable storage medium and contains machine-executable instructions. The machine-executable instructions, when executed by a device, cause the device to perform the method described according to the first aspect of the present disclosure.

The summary part is provided to introduce a selection of concepts in a simplified manner, which will be further described in the detailed description below. The summary part is neither intended to identify key features or essential features of the present disclosure, nor intended to limit the scope of the present disclosure.

### BRIEF DESCRIPTION OF THE DRAWINGS

The foregoing and other objectives, features, and advantages of the present disclosure will become more apparent from more detailed description of the example embodiments of the present disclosure in conjunction with the accompanying drawings. In the example embodiments of the present disclosure, like reference numerals usually represent like components.

FIG. 1A shows a block diagram of an example environment in which embodiments of the present disclosure can be implemented;

FIG. 1B shows a schematic diagram of a snapview backup;

FIG. 2 shows a schematic diagram of an example file list for creating a snapview backup;

FIG. 3 shows a schematic diagram of an example synthesis operation;

FIG. 4 shows a flowchart of an example method for creating a snapview backup according to an embodiment of the present disclosure;

FIG. 5 shows a schematic diagram of an example file list for creating a snapview backup according to an embodiment of the present disclosure;

FIG. 6 shows a schematic diagram of sorting files in a file list according to containers to which they belong according to an embodiment of the present disclosure;

FIG. 7 shows a flowchart of an example method for referencing data of files in containers according to an embodiment of the present disclosure;

FIG. 8 shows a flowchart of an example method for merging a plurality of synthesis operations for continuous files according to an embodiment of the present disclosure; and

FIG. 9 shows a block diagram of an example electronic device that may be used to implement the embodiments of the content of the present disclosure.

In the accompanying drawings, like or corresponding numerals represent like or corresponding parts.

### DETAILED DESCRIPTION

Preferred embodiments of the present disclosure will be described in more detail below with reference to the accompanying drawings. Although the preferred embodiments of the present disclosure are shown in the accompanying drawings, it should be understood that the present disclosure can be implemented in various forms and should not be limited by the embodiments set forth herein. Rather, these embodiments are provided to make the present disclosure more thorough and complete and to fully convey the scope of the present disclosure to those skilled in the art.

The term “include” and its variants as used herein indicate open-ended inclusion, i.e., “including, but not limited to.” Unless specifically stated, the term “or” indicates “and/or.” The term “based on” indicates “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects. Other explicit and implicit definitions may also be included below.

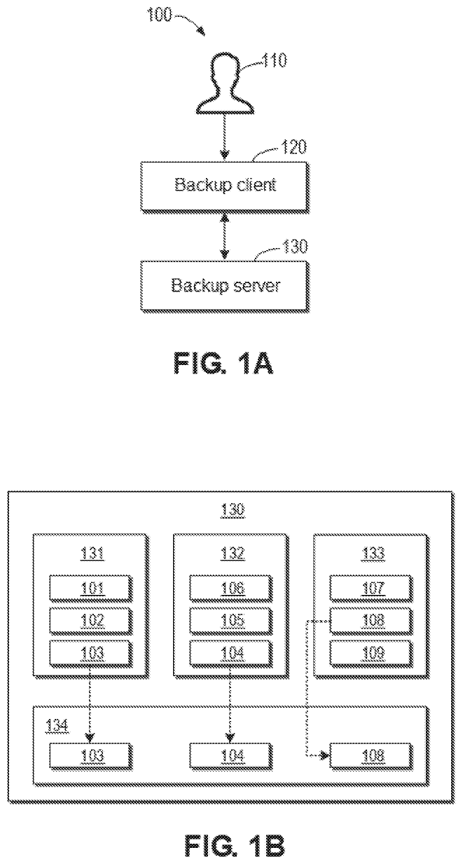

FIG. 1A shows a block diagram of an example environment 100 in which embodiments of the present disclosure can be implemented. It should be understood that the structure and function of environment 100 are described for illustrative purposes only, and do not imply any limitation to the scope of the present disclosure. For example, the embodiments of the present disclosure may also be applied to an environment different from environment 100.

As shown in FIG. 1A, environment 100 includes backup client 120 and backup server 130. User 110 may initiate a backup request to backup client 120 to back up files at backup client 120 to backup server 130. As shown in FIG. 1B, backup server 130 may include, for example, a plurality of backup files 131, 132, and 133 created at different times respectively. Backup file 131 may include data of files 101, 102, and 103. Backup file 132 may include data of files 104, 105, and 106. Backup file 133 may include data of files 107, 108, and 109.

In addition, user 110 may initiate a request to create a snapview backup to backup client 120. The request may include a file list corresponding to the snapview backup to be created, and the file list may indicate one or more files to be referenced by the snapview backup to be created.

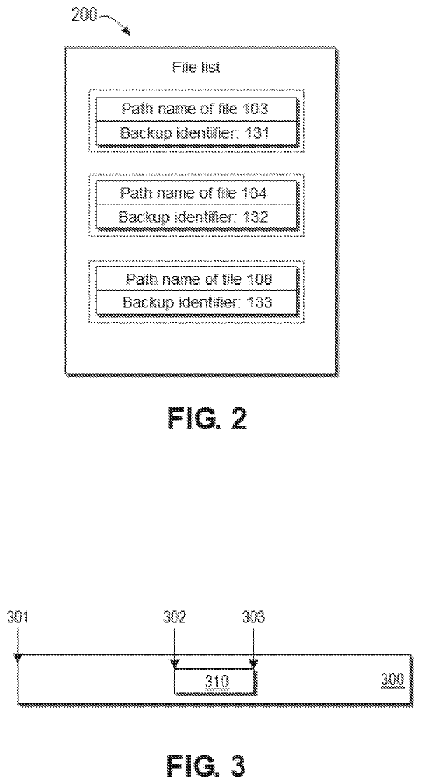

FIG. 2 shows a schematic diagram of example file list 200 for creating a snapview backup. As shown in FIG. 2, the snapview backup to be created involves, for example, files 103, 104, and 108 as shown in FIG. 1B. File list 200 may record a path name of file 103 and an identifier of backup file 131 to which file 103 belongs, a path name of file 104 and an identifier of backup file 132 to which file 104 belongs, and a path name of file 108 and an identifier of backup file 133 to which file 108 belongs.

According to example file list 200 as shown in FIG. 2, backup client 120 may send an operation request to the backup server to cause backup server 130 to create the snapview backup by referencing data of a corresponding file in existing backup files. FIG. 1B shows snapview backup 134 created at backup server 130, which references data of file 103 in existing backup file 131, data of file 104 in existing backup file 132, and data of file 108 in existing backup file 133.

File data at backup server 130 may be stored in units of containers. In this text, the term “container” refers to a data storage unit that stores corresponding file data of one or more files, which may exist in the form of a single file in a file system. By storing the file data of a plurality of files in the containers, the number of file system operations in data backup can be reduced. Corresponding file data in a backup file (e.g., backup file 131, 132, or 133) may be stored in one or more containers. Backup server 130 may create a snapview backup by referencing the corresponding file data in the containers according to a file list corresponding to the snapview backup.

In this text, the operation of referencing the file data in the containers is also referred to as a “synthesis operation” or “reference operation,” and “reference” and “synthesis” may be used interchangeably.

FIG. 3 shows a schematic diagram of an example synthesis operation. FIG. 3 shows container 300, which, for example, includes data of file 310. In order to reference the data of file 310, it is usually necessary to first determine position 301 of container 300 and open container 300. Then, start position 302 of file 310 in container 300 and the size of file 310 are determined, and end position 303 of file 310 in container 300 is determined based on start position 302 and the size of file 310. After start position 302 and end position 303 of file 310 in container 300 are determined, file 310 may be referenced by referencing data from start position 302 to end position 303 in container 300. Container 300 may be closed after the synthesis operation is completed. It should be understood that information such as the start position of each container, the offset of the file data of each file that has been backed up in the corresponding container, and the file size may be recorded at backup server 130 for query.

In a traditional solution, the efficiency of creating a snapview backup is usually relatively low. This is because users often do not know where files are stored in a backup server, so the users can create file lists corresponding to snapview backups at will, or create file lists corresponding to snapview backups based on some simple rules (such as alphabetical order). This will bring the following problems.

First, it may cause the same container to be repeatedly opened and closed multiple times. In the traditional solution, when a synthesis operation is performed, it is necessary to open a container before the synthesis operation and close the container after the synthesis operation is completed. This is because the file lists corresponding to the snapview backups are usually created in any order. Therefore, data of the next file to be referenced may be located in another container. If the container is not closed after each synthesis operation is completed, many unused but opened containers may be generated, and too many opened containers may cause problems with the backup server. Therefore, in the traditional solution, the containers are usually closed after the synthesis operations are completed. Since the users often do not know the containers where the backed up files are located, even if a plurality of files to be referenced are in the same container, the container will be repeatedly opened and closed.

Second, the efficiency of a synthesis operation performed on a plurality of files with continuous positions in the containers is not high. The file lists corresponding to the snapview backups may include the plurality of files with continuous positions in the containers. These files may be referenced via a single synthesis operation. However, since the order of files in the file lists corresponding to the snapview backups may be arbitrary, the plurality of files with continuous positions in the containers may not be continuous in the file lists. In this case, in the traditional solution, synthesis operations can only be performed on the plurality of files one by one, resulting in the same container being repeatedly opened and closed multiple times, thereby making the efficiency of creating a snapview backup relatively low.

Embodiments of the present disclosure provide a solution for creating a snapview backup, which may solve one or more of the foregoing problems and other potential problems. According to the solution, at a backup client, a first file list corresponding to a snapview backup to be created at a backup server is acquired. The first file list indicates a plurality of files to be referenced by the snapview backup, and data of the plurality of files is contained in a plurality of containers at the backup server. A second file list is generated by sorting the plurality of files indicated in the first file list according to the containers to which they belong. The second file list indicates that each of the plurality of containers contains data of at least one of the plurality of files. Then, the snapview backup is created by causing the backup server to reference the data of the plurality of files in the plurality of containers based on the second file list. In this way, the embodiments of the present disclosure can effectively reduce the number of file operations and message transfers in the process of creating a snapview backup, thereby improving the efficiency of creating the snapview backup.

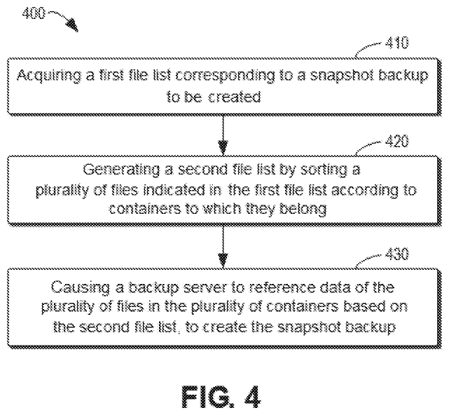

FIG. 4 shows a flowchart of example method 400 for creating a snapview backup according to an embodiment of the present disclosure. Method 400 may be performed, for example, by backup client 120 as shown in FIG. 1. It should be understood that method 400 may further include an additional action that is not shown and/or may omit an action that is shown, and the scope of the present disclosure is not limited in this regard. Method 400 is described in detail below with reference to FIG. 1A.

At block 410, backup client 120 acquires a first file list corresponding to a snapview backup to be created. For example, the first file list may be input by user 110 to backup client 120. An example of the first file list may be example file list 200 as shown in FIG. 2. The first file list may indicate a plurality of files to be referenced by the snapview backup to be created, where data of the plurality of files is contained in a plurality of containers at backup server 130.

At block 420, a second file list is generated by backup client 120 by sorting the plurality of files indicated in the first file list according to the containers to which they belong, where the second file list indicates that each of the plurality of containers contains data of at least one of the plurality of files.

In some embodiments, in order to generate the second file list, backup client 120 may acquire, from backup server 130, information related to the plurality of files indicated in the first file list. The information may indicate the position of the container to which each of the plurality of files belongs, the offset of each of the plurality of files in the container to which it belongs, and the file size. Backup client 120 may generate an intermediate file list for creating the snapview backup based on the information and the first file list.

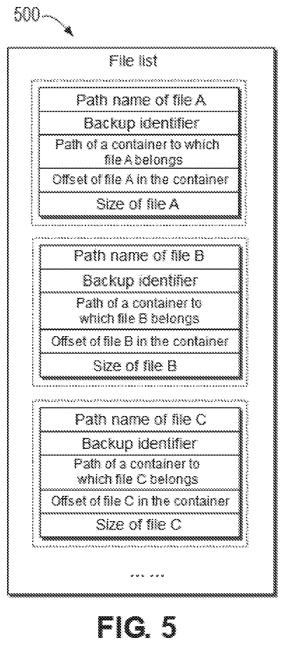

FIG. 5 shows a schematic diagram of example intermediate file list 500 for creating a snapview backup according to an embodiment of the present disclosure. As shown in FIG. 5, file list 500 may include a plurality of entries corresponding to a plurality of files to be referenced by the snapview backup. For example, an entry corresponding to file A may record a path name of file A, an identifier of a backup file to which file A belongs, a path of a container where data of file A is located, an offset (i.e., a start position) of file A within the container, and the size of file A.

In some embodiments, backup client 120 may respectively create corresponding sub-file lists for a plurality of containers involved based on the intermediate file list. Each sub-file list may correspond to a container and indicate a group of files in the container to be referenced by the snapview backup. Backup client 120 may generate a second file list by combining these sub-file lists.

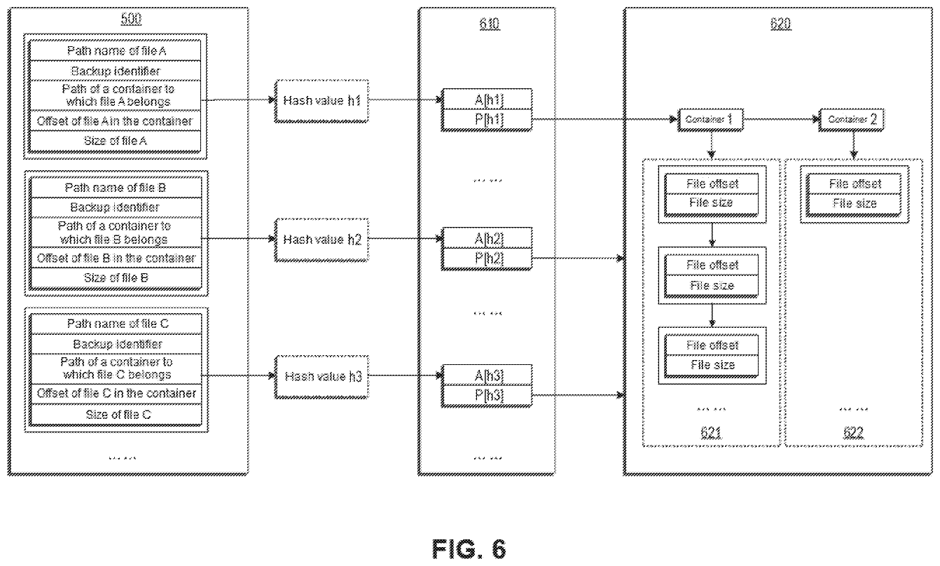

FIG. 6 shows a schematic diagram of sorting files in file list 500 according to containers to which they belong according to an embodiment of the present disclosure.

As shown in FIG. 6, backup client 120 may calculate a hash value for a path of the container to which each file in file list 500 belongs. For example, for file A, the hash value calculated for the path of the container to which it belongs is h1. In some embodiments, the hash value h1 may also be a complete hash value calculated for the path of the container to which file A belongs. Alternatively, the hash value h1 may also be several bits in the complete hash value calculated for the path of the container to which file A belongs, which is also referred to as a “truncated hash value.” Using the truncated hash value helps to improve the efficiency of subsequent searches. Backup client 120 may determine an index A[h1] in hash array 610 based on the hash value h1. An array value P[h1] corresponding to the index A[h1] will point to one or more sub-lists in sorted file list 620 (i.e., the second file list). The one or more sub-lists correspond to those containers whose container paths have the hash value h1, where each sub-list corresponds to a container and records a group of files in file list 500 involved in the container. It should be understood that hash array 610 may be pre-configured at backup client 120.

Depending on a hash function used to calculate the hash values, the hash values corresponding to paths of different containers may be the same; that is, a “collision” occurs. In some embodiments, the problem of hash value collision may be solved by checking the complete hash values and/or container paths. For example, in order to add file A to the correct sub-list, after P[h1] is determined, the path of the container to which file A belongs may be compared with the paths of the containers corresponding to the one or more sub-lists pointed to by P[h1]. If the path of the container to which file A belongs matches the path of the container corresponding to a certain sub-list (for example, sub-list 621), the entry corresponding to file A is added to sub-list 621. In some embodiments, the added entry may record the offset (i.e., a start position) and the file size of file A in the container. In some embodiments, in order to improve the efficiency of referencing files with continuous positions subsequently, the entries corresponding to the files may be added in an ascending order according to the start positions of the files in the containers. That is, the entry corresponding to a file whose start position is near the front will be added to a position near the head of the list, and the entry corresponding to a file whose start position is near the back will be added to a position near the end of the list. Alternatively, if the path of the container to which file A belongs does not match the paths of the containers corresponding to all existing sub-lists, a new sub-list (for example, sub-list 622) may be created for the container to which file A belongs, and the entry corresponding to file A is added to new sub-list 622.

In this way, backup client 120 can generate second file list 620 based on intermediate file list 500. Second file list 620 indicates a group of files contained in each of the plurality of containers involved in the snapview backup to be created. It should be understood that, second file list 620, sub-file lists 621 and 622 therein, etc., may be implemented using a linked list or any other suitable data structures, and the scope of the present disclosure is not limited in this regard.

Referring back to FIG. 4, at block 430, backup client 120 causes backup server 130 to reference the data of the plurality of files in the plurality of containers based on the second file list, to create the snapview backup. In some embodiments, backup client 120 may cause backup server 130 to open each of the plurality of containers involved in the second file list and reference the data of the group of files in the opened container. After the data of all the files involved in the container is synthesized, backup client 120 may cause backup server 130 to close the container. In this way, the embodiments of the present disclosure can effectively reduce the number of times the same container is repeatedly opened and closed in the process of creating a snapview backup, thereby improving the efficiency of creating the snapview backup.

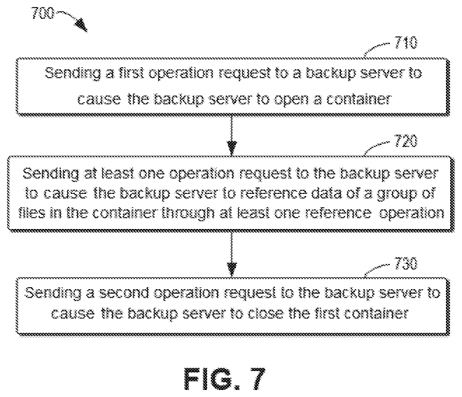

FIG. 7 shows a flowchart of example method 700 for referencing data of files in containers according to an embodiment of the present disclosure. Method 700 may be regarded as an example implementation of block 430 as shown in FIG. 4. In some embodiments, backup client 120 may perform method 700 for each of the plurality of containers involved in the second file list, thereby referencing the data of the files in these containers. It should be understood that method 700 may further include an additional action that is not shown and/or may omit an action that is shown, and the scope of the present disclosure is not limited in this regard.

As shown in FIG. 7, at block 710, backup client 120 sends a first operation request to backup server 130 to cause backup server 130 to open a container. In some embodiments, the container may be represented as a file in a file system, so the container may be opened by the operation of opening the file. For example, the first operation request may indicate the path of the container.

At block 720, backup client 120 sends at least one operation request to backup server 130 to cause backup server 130 to reference the data of a group of files in the container through at least one synthesis operation.

In some embodiments, for files with discontinuous positions in the group of files, backup client 120 may send an operation request for the files to backup server 130 so as to cause backup server 130 to reference data of the files in the container through the synthesis operation. Additionally or alternatively, for a plurality of files with continuous positions in the group of files, backup client 120 may send an operation request for the plurality of files to backup server 130 to cause backup server 130 to reference data of the plurality of files in the container through a single synthesis operation.

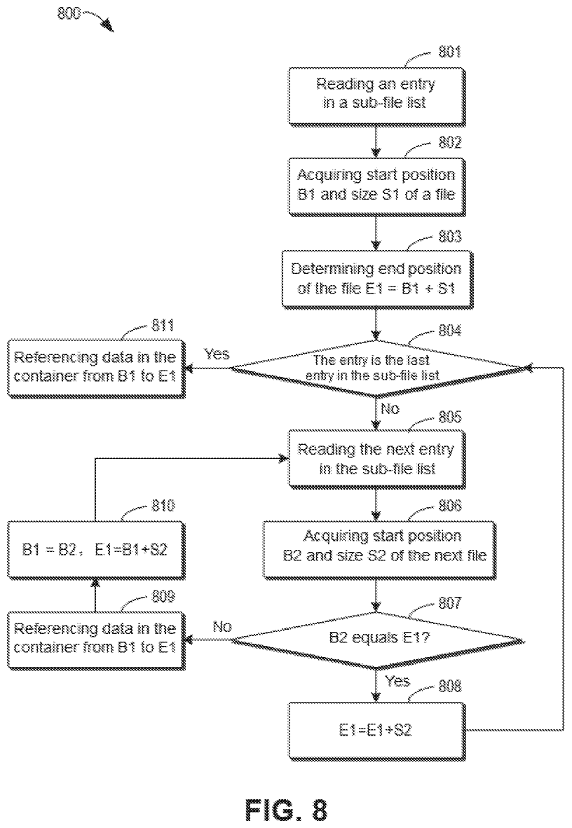

FIG. 8 shows a flowchart of example method 800 for merging a plurality of synthesis operations for continuous files according to an embodiment of the present disclosure. Method 800 may be regarded as an example implementation of block 720 as shown in FIG. 7. It should be understood that method 800 may further include an additional action that is not shown and/or may omit an action that is shown, and the scope of the present disclosure is not limited in this regard.

As shown in FIG. 8, at block 801, backup client 120 reads an entry in a sub-file list corresponding to the container. At block 802, backup client 120 acquires, from the entry, start position B1 and file size S1 of a file in the container recorded by the entry. At block 803, backup client 120 determines end position E1=B1+S1 of the file in the container based on start position B1 and file size S1 of the file.

At block 804, backup client 120 determines whether the entry is the last entry in the sub-file list. If yes, at block 811, backup client 120 sends an operation request to backup client 130 to reference data from B1 to E1 in the container. If not, at block 805, backup client 120 reads the next entry in the sub-file list.

At block 806, backup client 120 acquires, from the next entry, start position B2 and file size S2 of the next file in the container recorded by the next entry. At block 807, backup client 120 determines whether start position B2 of the next file is equal to end position E1 of the current file. If yes, at block 808, backup client 120 updates E1 to E1=E1+S2, and then method 800 proceeds to block 804. If not, at block 809, backup client 120 sends an operation request to backup client 130 to reference data in the container from B1 to E1.

At block 810, backup client 120 will update B1 with B2, that is, B1=B2, and update E1 to E1=B1+S2. Method 800 then proceeds to block 805.

In this way, when there are a plurality of files with continuous positions in the container in the sub-file list, backup client 120 can determine the start positions and the end positions of the plurality of files in the container, and send the operation request to backup server 130 to reference, through a single synthesis operation, the data in the container from the start positions to the end positions that are determined, thereby completing the reference to the file data of the plurality of files. Merging the synthesis operations for the plurality of files with continuous positions can effectively reduce the number of times the container is repeatedly opened and closed, and at the same time, reduce the number of message transfers between backup client 120 and backup server 130, thereby significantly improving the performance of creating the snapview backup.

Referring back to FIG. 7, at block 730, if it is determined that at least one reference operation is completed, backup client 120 sends a second operation request to backup server 130 to cause backup server 130 to close the container.

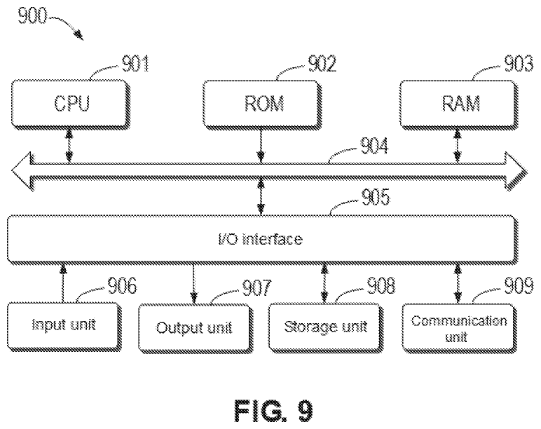

FIG. 9 shows a block diagram of example electronic device 900 that may be used to implement the embodiments of the content of the present disclosure. For example, backup client 120 and/or backup server 130 as shown in FIG. 1 may be implemented by electronic device 900. As shown in FIG. 9, device 900 includes central processing unit (CPU) 901 that may perform various appropriate actions and processing according to computer program instructions stored in read-only memory (ROM) 902 or computer program instructions loaded from storage unit 908 into random access memory (RAM) 903. In RAM 903, various programs and data required for the operation of device 900 may also be stored. CPU 901, ROM 902, and RAM 903 are connected to each other through bus 904. Input/output (I/O) interface 905 is also connected to bus 904.

A plurality of components in device 900 are connected to I/O interface 905, including: input unit 906, such as a keyboard and a mouse; output unit 907, such as various types of displays and speakers; storage unit 908, such as a magnetic disk and an optical disk; and communication unit 909, such as a network card, a modem, and a wireless communication transceiver. Communication unit 909 allows device 900 to exchange information/data with other devices over a computer network such as the Internet and/or various telecommunication networks.

The various processes and processing described above, such as methods 400, 700, and/or 800, may be performed by processing unit 901. For example, in some embodiments, methods 400, 700, and/or 800 may be implemented as a computer software program that is tangibly contained in a machine-readable medium, such as storage unit 908. In some embodiments, part or all of the computer program may be loaded and/or installed on device 900 via ROM 902 and/or communication unit 909. When the computer program is loaded onto RAM 903 and executed by CPU 901, one or more actions of methods 400, 700, and/or 800 described above may be performed.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions for use by an instruction execution device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device such as a punch card or a raised structure in a groove with instructions stored thereon, and any suitable combination of the foregoing. The computer-readable storage medium, as used herein, is not explained as transient signals themselves, such as radio waves or other freely propagating electromagnetic waves, electromagnetic waves propagating through waveguides or other transmission media (e.g., light pulses propagating through a fiber-optic cable), or electrical signals transmitted through an electrical wire.

The computer-readable program instructions described here can be downloaded from the computer-readable storage medium to various computing/processing devices, or downloaded to an external computer or an external storage device over a network such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium in each computing/processing device.

Computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages. The programming languages include object-oriented programming languages, such as Smalltalk and C++, and conventional procedural programming languages, such as “C” language or similar programming languages. The computer-readable program instructions may be executed entirely on a user computer, partly on a user computer, as a standalone software package, partly on a user computer and partly on a remote computer, or entirely on a remote computer or a server. In the case where a remote computer is involved, the remote computer can be connected to a user computer over any kind of networks, including a local area network (LAN) or a wide area network (WAN), or can be connected to an external computer (e.g., connected over the Internet using an Internet service provider). In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

Various aspects of the present disclosure are described here with reference to flowcharts and/or block diagrams of the method, the apparatus (the system), and the computer program product according to the embodiments of the present disclosure. It should be understood that each block in the flowcharts and/or block diagrams as well as a combination of blocks in the flowcharts and/or block diagrams may be implemented by using the computer-readable program instructions.

The computer-readable program instructions may be provided to a processing unit of a general purpose computer, a special purpose computer, or other programmable data processing apparatuses to produce a machine, such that the instructions, when executed by the processing unit of the computer or other programmable data processing apparatuses, generate an apparatus for implementing the functions/actions specified in one or more blocks in the flowcharts and/or block diagrams. The computer-readable program instructions may also be stored in a computer-readable storage medium, to cause a computer, a programmable data processing apparatus, and/or other devices to work in a specific manner, such that the computer-readable medium storing the instructions includes an article of manufacture that contains instructions for implementing various aspects of the functions/actions specified in one or more blocks in the flowcharts and/or block diagrams.

The computer-readable program instructions may also be loaded onto a computer, other programmable data processing apparatuses, or other devices, so that a series of operating steps are performed on the computer, other programmable data processing apparatuses, or other devices to produce a computer-implementing process. As such, the instructions executed on the computer, other programmable data processing apparatuses, or other devices implement the functions/actions specified in one or more blocks in the flowcharts and/or block diagrams.

The flowcharts and block diagrams in the accompanying drawings show the architectures, functionalities, and operations of possible implementations of the system, the method and the computer program product according to a plurality of embodiments of the present disclosure. In this regard, each block in the flowcharts or block diagrams may represent a module, a program segment, or part of instructions that contains one or more executable instructions for implementing specified logical functions. In some alternative implementations, the functions marked in the blocks may also occur in an order different from that marked in the accompanying drawings. For example, two successive blocks may actually be performed basically concurrently, and they may sometimes also be performed in a reverse order, depending on the functions involved. It should be further noted that each block in the block diagrams and/or flowcharts as well as a combination of the blocks in the block diagrams and/or flowcharts may be implemented by using a dedicated hardware-based system for executing specified functions or actions or by a combination of dedicated hardware and computer instructions.

Various embodiments of the present disclosure have been described above. The foregoing description is illustrative rather than exhaustive, and is not limited to the disclosed embodiments. Numerous modifications and alterations are apparent to those of ordinary skill in the art without departing from the scope and spirit of illustrated various embodiments. The selection of terms used herein is intended to best explain the principles and practical applications of the embodiments or the improvements to technologies on the market, or to enable other persons of ordinary skill in the art to understand the embodiments disclosed herein.

1. A method for creating a snapview backup, comprising:
acquiring, at a backup client, a first file list corresponding to the snapview backup to be created, the first file list indicating a plurality of files to be referenced by the snapview backup, and data of the plurality of files stored in a plurality of containers at a backup server;
generating a second file list by sorting the plurality of files indicated in the first file list according to the containers to which they belong, the second file list indicating that each of the plurality of containers comprises data of at least one of the plurality of files; and
causing the backup server to reference the data of the plurality of files in the plurality of containers based on the second file list, to create the snapview backup.

2. The method of claim 1, wherein the generating the second file list comprises:
acquiring, from the backup server, information related to the plurality of files, the information indicating a position of a container to which each of a second plurality of files belongs, and an offset and size of each of the second plurality of files in the container, wherein the container is one of the plurality of containers and each of the second plurality of files is one of the plurality of files;
creating, based on the information, a plurality of sub-file lists for the plurality of containers, each sub-file list indicating that a group of files in the plurality of files is contained in a corresponding container of the plurality of containers and indicating a corresponding offset and size of the group of files; and
combining the plurality of sub-file lists to generate the second file list.

3. The method of claim 1,
wherein the second file list indicates that the plurality of containers comprise a first container and the first container comprises data of a group of files in the plurality of files, and
wherein causing the backup server to reference the data of the plurality of files in the plurality of containers based on the second file list comprises:
sending a first operation request to the backup server to cause the backup server to open the first container;
sending at least one operation request to the backup server to cause the backup server to reference the data of the group of files in the first container; and
if it is determined that the at least one operation request is completed, sending a second operation request to the backup server to cause the backup server to close the first container.

4. The method of claim 3,
wherein the group of files comprises a first file, and
wherein sending the at least one operation request to the backup server comprises:
determining a first start position and a first end position of the first file in the first container; and
sending a third operation request to the backup server to cause the backup server to reference data between the first start position and the first end position in the first container.

5. The method of claim 4,
wherein the group of files further comprises a second file and a third file, and
wherein sending the at least one operation request to the backup server comprises:
determining a second start position and a second end position of the second file in the first container, and a third start position and a third end position of the third file in the first container; and
if it is determined that the second end position and the third start position are the same, sending a fourth operation request to the backup server to cause the backup server to reference data between the second start position and the third end position in the first container through a single reference operation.

6. The method of claim 5, wherein the sending the at least one operation request to the backup server further comprises:
if it is determined that the second end position and the third start position are different:
sending a fifth operation request to the backup server to cause the backup server to reference data between the second start position and the second end position in the first container; and
sending a sixth operation request to the backup server to cause the backup server to reference data between the third start position and the third end position in the first container.

7. An electronic device, comprising:
at least one processing unit; and
at least one memory coupled to the at least one processing unit and storing instructions for execution by the at least one processing unit, wherein the instructions, when executed by the at least one processing unit, cause the electronic device to perform a method, the method comprising:
acquiring, at a backup client, a first file list corresponding to the snapview backup to be created, the first file list indicating a plurality of files to be referenced by a snapview backup, and data of the plurality of files stored in a plurality of containers at a backup server;
generating a second file list by sorting the plurality of files indicated in the first file list according to the containers to which they belong, the second file list indicating that each of the plurality of containers comprises data of at least one of the plurality of files; and
causing the backup server to reference the data of the plurality of files in the plurality of containers based on the second file list, to create the snapview backup.

8. The electronic device of claim 7, wherein the generating the second file list comprises:
acquiring, from the backup server, information related to the plurality of files, the information indicating a position of a container to which each of a second plurality of files belongs, and an offset and size of each of the second plurality of files in the container, wherein the container is one of the plurality of containers and each of the second plurality of files is one of the plurality of files;
creating, based on the information, a plurality of sub-file lists for the plurality of containers, each sub-file list indicating that a group of files in the plurality of files is contained in a corresponding container of the plurality of containers and indicating a corresponding offset and size of the group of files; and
combining the plurality of sub-file lists to generate the second file list.

9. The electronic device of claim 7,
wherein the second file list indicates that the plurality of containers comprise a first container and the first container comprises data of a group of files in the plurality of files, and
wherein causing the backup server to reference the data of the plurality of files in the plurality of containers based on the second file list comprises:
sending a first operation request to the backup server to cause the backup server to open the first container;
sending at least one operation request to the backup server to cause the backup server to reference the data of the group of files in the first container; and
if it is determined that the at least one operation request is completed, sending a second operation request to the backup server to cause the backup server to close the first container.

10. The electronic device of claim 9,
wherein the group of files comprises a first file, and
wherein sending the at least one operation request to the backup server comprises:
determining a first start position and a first end position of the first file in the first container; and
sending a third operation request to the backup server to cause the backup server to reference data between the first start position and the first end position in the first container.

11. The electronic device of claim 10,
wherein the group of files further comprises a second file and a third file, and
wherein sending the at least one operation request to the backup server comprises:
determining a second start position and a second end position of the second file in the first container, and a third start position and a third end position of the third file in the first container; and
if it is determined that the second end position and the third start position are the same, sending a fourth operation request to the backup server to cause the backup server to reference data between the second start position and the third end position in the first container through a single reference operation.

12. The electronic device of claim 11, wherein the sending the at least one operation request to the backup server further comprises:
if it is determined that the second end position and the third start position are different:
sending a fifth operation request to the backup server to cause the backup server to reference data between the second start position and the second end position in the first container; and
sending a sixth operation request to the backup server to cause the backup server to reference data between the third start position and the third end position in the first container.

13. A computer-readable storage medium containing machine-executable instructions, wherein the machine-executable instructions, when executed by a device, cause the device to perform a method, the method comprising
acquiring, at a backup client, a first file list corresponding to the snapview backup to be created, the first file list indicating a plurality of files to be referenced by the snapview backup, and data of the plurality of files stored in a plurality of containers at a backup server;
generating a second file list by sorting the plurality of files indicated in the first file list according to the containers to which they belong, the second file list indicating that each of the plurality of containers comprises data of at least one of the plurality of files; and
causing the backup server to reference the data of the plurality of files in the plurality of containers based on the second file list, to create the snapview backup.

14. The computer-readable storage medium of claim 13, wherein the generating the second file list comprises:
acquiring, from the backup server, information related to the plurality of files, the information indicating a position of a container to which each of a second plurality of files belongs, and an offset and size of each of the second plurality of files in the container, wherein the container is one of the plurality of containers and each of the second plurality of files is one of the plurality of files;
creating, based on the information, a plurality of sub-file lists for the plurality of containers, each sub-file list indicating that a group of files in the plurality of files is contained in a corresponding container of the plurality of containers and indicating a corresponding offset and size of the group of files; and
combining the plurality of sub-file lists to generate the second file list.

15. The computer-readable storage medium of claim 13,
wherein the second file list indicates that the plurality of containers comprise a first container and the first container comprises data of a group of files in the plurality of files, and
wherein causing the backup server to reference the data of the plurality of files in the plurality of containers based on the second file list comprises:
sending a first operation request to the backup server to cause the backup server to open the first container;
sending at least one operation request to the backup server to cause the backup server to reference the data of the group of files in the first container; and
if it is determined that the at least one operation request is completed, sending a second operation request to the backup server to cause the backup server to close the first container.

16. The computer-readable storage medium of claim 15,
wherein the group of files comprises a first file, and
wherein sending the at least one operation request to the backup server comprises:
determining a first start position and a first end position of the first file in the first container; and
sending a third operation request to the backup server to cause the backup server to reference data between the first start position and the first end position in the first container.

17. The computer-readable storage medium of claim 16,
wherein the group of files further comprises a second file and a third file, and
wherein sending the at least one operation request to the backup server comprises:
determining a second start position and a second end position of the second file in the first container, and a third start position and a third end position of the third file in the first container; and
if it is determined that the second end position and the third start position are the same, sending a fourth operation request to the backup server to cause the backup server to reference data between the second start position and the third end position in the first container through a single reference operation.

18. The computer-readable storage medium of claim 17, wherein the sending the at least one operation request to the backup server further comprises:
if it is determined that the second end position and the third start position are different:
sending a fifth operation request to the backup server to cause the backup server to reference data between the second start position and the second end position in the first container; and
sending a sixth operation request to the backup server to cause the backup server to reference data between the third start position and the third end position in the first container.
